(19) United States
(12) Patent Application Publication
(10) Pub. No.: US 2026/0133522 A1
(43) Pub. Date: May 14, 2026

(54) SHUTTER MECHANISM AND IMAGE FORMING APPARATUS

(71) Applicant: Hotaru HASHIKAWA, Kanagawa (JP)

(72) Inventor: Hotaru HASHIKAWA, Kanagawa (JP)

(21) Appl. No.: 19/337,958

(22) Filed: Sep. 24, 2025

(30) Foreign Application Priority Data
Nov. 13, 2024 (JP) 2024-197875

(51) Int. Cl. G03G 15/08

(52) U.S. Cl. CPC G03G 15/0886

(57) ABSTRACT

A shutter mechanism includes a shutter, an elastic seal, and a sealing sheet. The shutter has a shutter opening and is slidably movable with respect to a fluid supply passage in a first direction to open the fluid supply passage. The elastic seal has a seal opening communicating with the fluid supply passage and a first face adhered to an edge portion of the fluid supply passage to seal a gap between the shutter and the edge portion of the fluid supply passage. The sealing sheet is adhered to a second face of the elastic seal opposite to the first face, is disposed between the elastic seal and the shutter, and has a sheet opening and a bent portion. The bent portion is bent at an edge of the elastic seal in a second direction away from the shutter and at an angle with respect to the first direction.

### CROSS-REFERENCE TO RELATED APPLICATION

This patent application is based on and claims priority pursuant to 35 U.S.C. § 119 (a) to Japanese Patent Application No. 2024-197875, filed on Nov. 13, 2024, in the Japan Patent Office, the entire disclosure of which is hereby incorporated by reference herein.

### BACKGROUND

### Technical Field

The present disclosure relates to a shutter mechanism that opens and closes a fluid supply passage in which fluid such as developer flows out or flows in, and an image forming apparatus, such as a copier, a printer, a facsimile machine, or a multifunction peripheral (MFP) thereof including the shutter mechanism.

### Related Art

In an image forming apparatus such as a copying machine or a printer, an image forming apparatus is widely known that includes a shutter mechanism that opens and closes a fluid supply passage (toner supply port) in order to prevent leakage of toner (developer) from the fluid supply passage installed in a toner supply device or a developing device.

### SUMMARY

The present disclosure described herein provides a shutter mechanism that includes a shutter, an elastic seal, and a sealing sheet. The shutter has a shutter opening and is slidably movable with respect to a fluid supply passage in a first direction to open the fluid supply passage to supply fluid through the fluid supply passage. The elastic seal has a seal opening communicating with the fluid supply passage and a first face adhered to an edge portion of the fluid supply passage to seal a gap between the shutter and the edge portion of the fluid supply passage. The sealing sheet is adhered to a second face of the elastic seal opposite to the first face and is disposed between the elastic seal and the shutter. The sealing sheet has a sheet opening and a bent portion. The sheet opening communicates with the seal opening. The bent portion is bent at an edge of the elastic seal in a second direction away from the shutter toward the fluid supply passage and at an angle with respect to the first direction.

The present disclosure described herein also provides an image forming apparatus that includes the shutter mechanism, a developing device, and a developer supply device. The developer supply device includes the fluid supply passage to supply the fluid including developer to the developing device through the fluid supply passage. The shutter mechanism is disposed between the fluid supply passage of the developer supply device and the developing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a cross-sectional view of an image forming device of the image forming apparatus of FIG. 1;

FIG. 3 is a diagram illustrating an overall configuration of a toner supply device and a developing device;

FIGS. 4A and 4B are cross-sectional views of a shutter mechanism and a vicinity of the shutter mechanism;

FIG. 5 is a cross-sectional view of an elastic seal and a sealing sheet;

FIG. 6 is a perspective view of a shutter mechanism;

FIG. 7 is a perspective view of a shutter mechanism as a comparative example;

FIG. 8 is a perspective view of a shutter mechanism as a first modification;

FIGS. 9A and 9B are cross-sectional views of a shutter mechanism and a vicinity of the shutter mechanism as a second modification;

FIGS. 10A and 10B are cross-sectional views of a shutter as a third modification;

FIGS. 11A and 11B are cross-sectional views of a shutter mechanism and a vicinity of the shutter mechanism as a fourth modification; and

FIGS. 12A and 12B are cross-sectional views of a shutter mechanism and a vicinity of the shutter mechanism as a fifth modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Identical reference numerals are assigned to identical or equivalent components and a description of those components may be simplified or omitted. As used herein, the singular forms “a,” “an,” and “the” are intended to include the plural forms as well, unless the context clearly indicates otherwise.

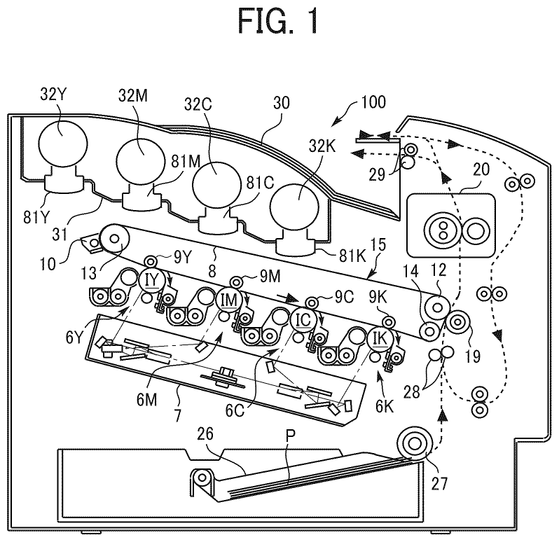

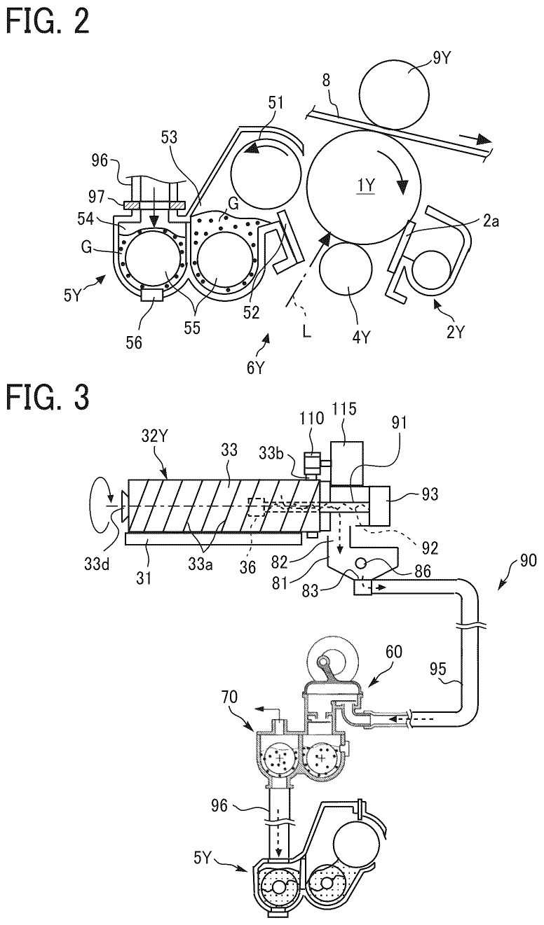

With reference to FIGS. 1 to 3, a description is given of an overall configuration and operation of an image forming apparatus 100 according to an embodiment of the present disclosure. FIG. 1 is a schematic view of a printer as the image forming apparatus 100. FIG. 2 is an enlarged view of an image forming device of the image forming apparatus 100. FIG. 3 is a schematic view of a toner supply device and the vicinity thereof. As illustrated in FIG. 1, a body of the image forming apparatus 100 includes an installation section 31 (serving as a toner container rack) in an upper portion of a body of the image forming apparatus 100. Substantially cylindrical toner containers 32Y, 32M, 32C, and 32K are detachably (replaceably) attached to the installation section 31. The four toner containers 32Y, 32M, 32C, and 32K correspond to four colors, that is, yellow, magenta, cyan, and black, respectively. Hoppers 81Y, 81M, 81C, and 81K of toner supply devices are disposed below the toner containers 32Y, 32M, 32C, and 32K, respectively. An intermediate transfer unit 15 is disposed below the installation section 31. Image forming devices 6Y, 6M, 6C, and 6K corresponding to colors of yellow, magenta, cyan, and black, respectively, are arranged side by side to face an intermediate transfer belt 8 of the intermediate transfer unit 15.

With reference to FIG. 2, the image forming device 6Y for yellow includes a photoconductor drum 1Y (an image bearer), a charging device 4Y, a developing device 5Y, a cleaning device 2Y, and a charge elimination device disposed around the photoconductor drum 1Y. Image forming processes (i.e., a charging process, an exposure process, a development process, a transfer process, a cleaning process, and an electric-charge removing process) are executed on the photoconductor drum 1Y. Thus, a yellow toner image is formed on the surface of the photoconductor drum 1Y.

The other three image forming devices 6M, 6C, and 6K have substantially the same configuration as that of the image forming device 6Y for yellow except for the color of toner used therein and form magenta, cyan, and black toner images, respectively. The image forming device 6Y is described below and descriptions of the other three image forming devices 6M, 6C, and 6K are appropriately omitted.

As illustrated in FIG. 2, a motor drives to rotate the photoconductor drum 1Y clockwise. The charging device 4Y uniformly charges the surface of the photoconductor drum 1Y (a charging process). When the surface of the photoconductor drum 1Y reaches a position at which the surface of the photoconductor drum 1Y is irradiated with laser beam L emitted from an exposure device 7 (a writing device, see FIG. 1), the photoconductor drum 1Y is scanned with the laser beam L. Thus, an electrostatic latent image corresponding to yellow is formed on the photoconductor drum 1Y (an exposure process).

When the surface of the photoconductor drum 1Y reaches a position facing the developing device 5Y, the electrostatic latent image is developed with toner into a yellow toner image (development process). When the surface of the photoconductor drum 1Y bearing the toner image reaches a position facing a primary transfer roller 9Y via the intermediate transfer belt 8, at the position, the toner image on the photoconductor drum 1Y is transferred onto the intermediate transfer belt 8 (a primary transfer process). After the primary transfer process, a small amount of toner may remain untransferred on the photoconductor drum 1Y.

When the surface of the photoconductor drum 1Y reaches a position facing the cleaning device 2Y, a cleaning blade 2a collects the untransferred toner from the photoconductor drum 1Y into the cleaning device 2Y (a cleaning process). Finally, the surface of the photoconductor drum 1Y reaches a position facing a charge neutralizer, and the charge elimination device removes residual potentials from the photoconductor drum 1Y. Thus, a series of image forming processes executed on the surface of the photoconductor drum 1Y is completed.

The other image forming devices 6M, 6C, and 6K perform the series of image forming processes described above in substantially the same manner as the image forming device 6Y for yellow. In other words, the exposure device 7 disposed below the image forming devices 6M, 6C, and 6K irradiates photoconductor drums 1M, 1C, and 1K of the image forming devices 6M, 6C, and 6K, respectively, with the laser beams L based on image data. Specifically, the exposure device 7 includes a light source to emit the laser beams L, multiple optical elements, and a polygon mirror rotated by a motor. The exposure device 7 scans, with the laser beams L, the photoconductor drums 1M, 1C, and 1K via the multiple optical elements while deflecting the laser beams L with the polygon mirror. Then, toner images formed on the photoconductor drums 1M, 1C, and 1K through the development step are transferred and superimposed onto the intermediate transfer belt 8. Thus, a color toner image is formed on the intermediate transfer belt 8.

The intermediate transfer unit 15 includes the intermediate transfer belt 8, four primary transfer rollers 9Y, 9M, 9C, and 9K, a secondary transfer counter roller 12, a cleaning backup roller 13, a tension roller 14, and an intermediate transfer cleaning device 10. The intermediate transfer belt 8 is extended and supported by the secondary transfer counter roller 12, the cleaning backup roller 13, and the tension roller 14. The secondary transfer counter roller 12 serves as a driving roller to rotate the intermediate transfer belt 8 in the direction (counterclockwise) indicated by an arrow in FIG. 1.

The four primary transfer rollers 9Y, 9M, 9C, and 9K are pressed against the corresponding photoconductor drums 1Y, 1M, 1C, and 1K, respectively, via the intermediate transfer belt 8 to form primary transfer nips. A primary transfer bias opposite in polarity to toner is applied to the primary transfer rollers 9Y, 9M, 9C, and 9K. The intermediate transfer belt 8 travels in the direction (counterclockwise) indicated by an arrow in FIG. 1 and sequentially passes through the primary transfer nips of the primary transfer rollers 9Y, 9M, 9C, and 9K. As a result, the single-color toner images on the photoconductor drums 1Y, 1M, 1C, and 1K, having the respective colors, are primarily transferred and superimposed onto the intermediate transfer belt 8, thereby forming the multicolor toner image.

Subsequently, the intermediate transfer belt 8 onto which the toner images of the respective colors are transferred and superimposed reaches a position opposite a secondary transfer roller 19. At this position, the intermediate transfer belt 8 is nipped between the secondary transfer counter roller 12 and the secondary transfer roller 19 to form a secondary transfer nip. The toner images of four colors formed on the intermediate transfer belt 8 are transferred onto a sheet P such as a sheet of paper conveyed to the position of the secondary transfer nip (a secondary transfer process). At this time, the untransferred toner that has not been transferred onto the sheet P remains on the surface of the intermediate transfer belt 8.

The surface of the intermediate transfer belt 8 then reaches a position opposite the intermediate transfer cleaning device 10. At this position, the intermediate transfer cleaning device 10 collects the untransferred toner from the intermediate transfer belt 8. Thus, a series of transfer processes performed on the intermediate transfer belt 8 ends.

The sheet P is conveyed from a sheet feeder 26 disposed in a lower portion of the body of the image forming apparatus 100 to the secondary transfer nip via a feed roller 27 and a registration roller pair 28. Specifically, the sheet feeder 26 contains a stack of multiple sheets P such as sheets of paper stacked on one on another. As the feed roller 27 is rotated counterclockwise in FIG. 1, the feed roller 27 feeds a top sheet P from the stack in the sheet feeder 26 to a roller nip between rollers of the registration roller pair 28.

The sheet P conveyed to the registration roller pair 28 (serving as a timing roller pair) temporarily stops at the roller nip between the rollers of the registration roller pair 28 that has stopped driving to rotate. The registration roller pair 28 is rotated at a timing at which the sheet P meets the color toner image on the intermediate transfer belt 8 at the secondary transfer nip, to convey the sheet P toward the secondary transfer nip. Thus, the desired color image is transferred onto the sheet P.

Subsequently, the sheet P, onto which the color toner image is transferred at the secondary transfer nip, is conveyed to a position of a fixing device 20. Then, at this position, the color toner image transferred to the surface of the sheet P is fixed on the sheet P by heat and pressure of the fixing roller and the pressure roller (a fixing process). The sheet P is conveyed through the rollers of an output roller pair 29 and ejected to the outside of the image forming apparatus 100. The sheets P ejected by the output roller pair 29 to the outside of the image forming apparatus 100 are sequentially stacked as output images on a stack tray 30. Thus, a series of image forming processes performed by the image forming apparatus 100 is completed.

Next, a detailed description is given of a configuration and operations of the developing device as a supplied portion of the image forming unit with reference to FIG. 2. The developing device 5Y includes a developing roller 51, a doctor blade 52, two conveying screws 55, and a toner concentration sensor 56. The developing roller 51 faces the photoconductor drum 1Y. The doctor blade 52 faces the developing roller 51. The two conveying screws 55 are disposed within developer housings 53 and 54. The toner concentration sensor 56 detects a concentration of toner in developer G. The developing roller 51 includes magnets and a sleeve. The magnets are fixed inside the developing roller 51. The sleeve rotates around the magnets. The developer housings 53 and 54 contain the two-component developer G including carrier (i.e., carrier particles) and toner (i.e., toner particles). The developing device 5Y is attachable to and detachable from (replaceable with) the body of the image forming apparatus 100 (a toner supply device 90).

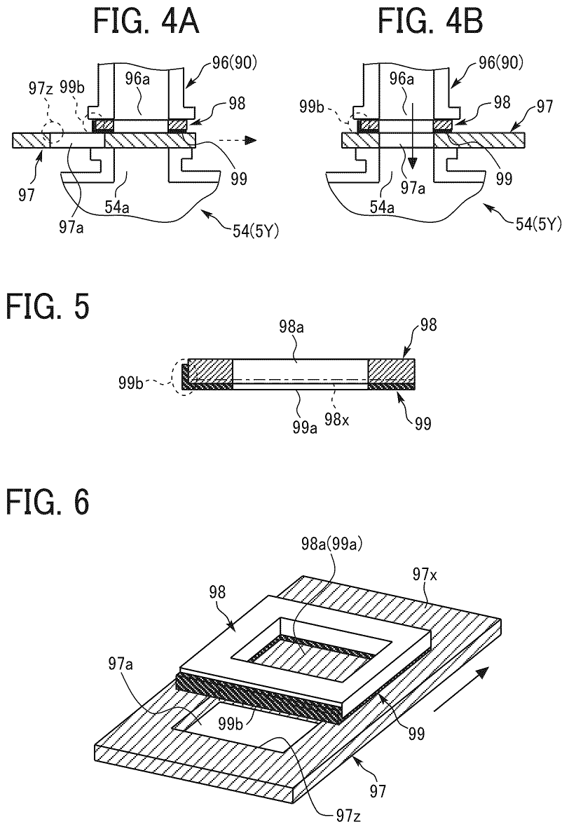

The developing device 5Y described above operates as follows. The sleeve of the developing roller 51 rotates in the direction indicated by an arrow in FIG. 2. The developer G is borne on the developing roller 51 by a magnetic field generated by the magnets. As the sleeve rotates, the developer G moves along the circumference of the developing roller 51. The developer G in the developing device 5Y is adjusted so that the ratio of toner (i.e., toner concentration) in the developer G is within a specified range. Specifically, the toner supply device 90 (see FIG. 3) serving as a supply device that supplies toner from the toner container 32Y to a developer housing 54 (see FIG. 2) according to the toner consumption in the developing device 5Y. The image forming apparatus 100 according to the present embodiment is provided with a shutter 97 that opens and closes a toner outlet 96a (a fluid supply passage) of a conveying tube 96 of the toner supply device 90 that allows toner (fluid) to flow out toward the developing device 5Y (the developer housing 54), which is described in detail later with reference to FIGS. 4A and 4B.

The toner supplied in the developer housing 54 is stirred and mixed together with the developer G and circulated through the two developer housings 53 and 54 by the two conveying screws 55 (i.e., in a longitudinal direction perpendicular to the plane on which FIG. 2 is illustrated). The toner in the developer G is electrically charged by friction together with the carrier and thus is attracted to the carrier. Both the toner and the carrier are borne on the developing roller 51 due to a magnetic force generated on the developing roller 51. The developer G borne on the developing roller 51 is conveyed in a direction (counterclockwise) indicated by an arrow in FIG. 3 and reaches a position opposite the doctor blade 52. The doctor blade 52 adjusts the amount of the developer borne on the developing roller 51 to an appropriate amount. Thereafter, the developer G on the developing roller 51 is conveyed to a position opposite the photoconductor drum 1Y (a developing area). The toner is attracted to the electrostatic latent image formed on the photoconductor drum 1Y by an electric field generated in the development area. Subsequently, as the sleeve rotates, the developer G remaining on the developing roller 51 reaches an upper portion of the developer housing 53 and separates from the developing roller 51.

Next, with reference to FIG. 3, a configuration and operations of the toner supply device 90 serving as the supply device is briefly described. The toner supply device 90 rotationally drives a container body 33 of the toner container 32Y disposed in the installation section 31 in a specified direction (in the direction indicated by an arrow in FIG. 3), discharges toner as fluid (powder) contained in the toner container 32Y to the outside of the toner container 32Y, and guides the toner to the developing device 5Y via a sub-hopper 70. The toner supply device 90 includes a toner supply passage (a toner conveyance passage). In FIG. 3, the arrangement direction of the toner container 32Y, the toner supply device 90, and the developing device 5Y is changed to facilitate understanding. Actually, the longitudinal axes of the toner container 32Y and a part of the toner supply device 90 are perpendicular to the plane on which FIG. 3 is illustrated (see FIG. 1). In addition, the orientation and arrangement of conveying tubes 95 and 96 are also simplified and illustrated.

The toner supply devices 90 supply the color toners contained in the toner containers 32Y, 32M, 32C, and 32K installed in the installation section 31 in the body of the image forming apparatus 100 to the corresponding developing devices 5Y, 5M, 5C, and 5K, respectively. The amount of toner supplied to each developing device 5 is determined based on the amount of toner consumed in the corresponding developing device 5. The four toner supply devices 90 have a similar configuration except the color of the toner used in the image forming processes. Specifically, with reference to FIG. 3, when the toner container 32Y is attached to the installation section 31 of the body of the image forming apparatus 100, a toner conveying nozzle 91 of the body of the image forming apparatus 100 pushes and moves a shutter 36 of the toner container 32Y. As a result, the toner conveying nozzle 91 is inserted into the toner container 32Y (the container body 33). Accordingly, the toner contained in the toner container 32Y can be discharged through the toner conveying nozzle 91. The toner container 32Y includes a grip 33d at the bottom portion (the left in FIG. 3) of the toner container 32Y so that a user easily attaches the toner container 32Y to the installation section 31. The user grips the grip 33d to install the toner container 32Y in the installation section 31 and take out the toner container 32Y from the installation section 31.

With reference to FIGS. 3, 4A, and 4B, the toner container 32Y includes the substantially cylindrical container body 33 having a spiral groove 33a extending in the longitudinal direction (the left-and-right directions in FIG. 3, and the axial direction of the container body 33). Specifically, the spiral groove 33a is formed from an outer circumferential surface toward an inner circumferential surface of the container body 33 so that a rotation of the container body 33 convey the toner in the container body 33 from the left to the right in FIG. 3. The toner conveyed from the left to the right in FIG. 3 inside the container body 33 is discharged to the outside of the toner container 32Y through the toner conveying nozzle 91. The toner container 32Y includes a gear 33b meshing with a drive gear 110 of the body of the image forming apparatus 100. The gear 33b is disposed on the outer circumferential surface of the container body 33 on a head side (on the right side of the container body 33 in FIG. 3). When the toner container 32Y is installed to the installation section 31, the gear 33b of the container body 33 meshes with the drive gear 110 of the body of the image forming apparatus 100. As a drive motor 115 is driven, the driving force (rotational drive) is transmitted from the drive gear 110 to the gear 33b, thus driving the container body 33 to rotate. In other words, the drive motor 115 and the drive gear 110 function as a drive mechanism to drive to rotate the container body 33.

With reference to FIG. 3, a conveying screw 92 is disposed inside the toner conveying nozzle 91. As a motor 93 drives to rotate the conveying screw 92, the conveying screw 92 conveys the toner flowing into the toner conveying nozzle 91 in the toner container 32Y from the left to the right in FIG. 3. Thus, the toner is discharged through an outlet port of the toner conveying nozzle 91 to a hopper 81. The hopper 81 is disposed below the outlet port of the toner conveying nozzle 91 via a dropping passage 82. The toner stored in the hopper 81 is conveyed to the developing device 5Y downstream from the hopper 81 by a conveyor. The conveyance configuration by the conveyor in FIG. 3 is described below. A suction port 83 is disposed in the bottom portion of the hopper 81 and coupled to one end of the conveying tube 95 as a tube. The conveying tube 95 is made of a flexible rubber material with low affinity for toner, and the other end of the conveying tube 95 is coupled to a developer pump 60 (serving as a diaphragm pump). The developer pump 60 is coupled to the developing device 5Y via the sub-hopper 70 and the conveying tube 96. With such a configuration of the toner supply device 90, the drive motor 115 as the drive mechanism rotates the container body 33 of the toner container 32Y to discharge the toner stored in the toner container 32Y to the outside of the toner container 32Y through the toner conveying nozzle 91. The toner discharged from the toner container 32Y falls through the dropping passage 82 and is stored in the hopper 81. The developer pump 60 operates to suck the toner stored in the hopper 81 together with air from the suction port 83 and convey the toner from the developer pump 60 to the sub-hopper 70 through the conveying tube 95. The toner conveyed to and stored in the sub-hopper 70 is appropriately supplied into the developing device 5Y via the conveying tube 96. In other words, the toner in the toner container 32Y is conveyed in the direction indicated by dashed arrows in FIG. 3. The conveyor is not limited to the above-described configuration, and for example, the toner stored in the hopper 81 may be conveyed directly to the developing device 5Y by a screw disposed in the hopper 81.

A toner sensor 86 is disposed near the suction port 83 and indirectly detects a state in which the toner contained in the toner container 32Y is depleted (i.e., toner end state) or a state in which the toner contained in the toner container 32Y is nearly depleted (i.e., toner near end state). The toner is discharged from the toner container 32Y based on the detection result of the toner sensor 86. Specifically, for example, a piezoelectric sensor or a light transmission sensor can be used as the toner sensor 86. A height of the detection surface of the toner sensor 86 is set so that the amount of toner (deposition height) deposited above the suction port 83 is a target value. A drive timing and a drive duration of the drive motor 115 are controlled to rotationally drive the toner container 32Y (container body 33) based on the detection result of the toner sensor 86. Specifically, when the toner sensor 86 detects that toner is not deposited on a detection position of the toner sensor 86, the drive motor 115 is driven for a specified time. When the toner sensor 86 detects that toner is present on the detection position, the drive motor 115 stops. If the toner sensor 86 continuously detects that there is not toner at the detection position even when the above-described control is performed repeatedly, a controller of the image forming apparatus determines that the toner contained in the toner container 32Y is depleted (i.e., toner end state) or that the toner contained in the toner container 32Y is nearly depleted (i.e., toner near end state).

With reference to FIGS. 4A, 4B, and 6, a description is given in detail below of a shutter mechanism (97, 98, and 99) of the image forming apparatus 100 according to the present embodiment. As illustrated in FIGS. 4A and 4B (and FIG. 2), the image forming apparatus 100 in the present embodiment is provided with the shutter mechanism (97, 98, and 99) for communicating and blocking the toner supply passage from the toner supply device 90 (the conveying tube 96) to the developing device 5Y (the developer housing 54). With reference to FIGS. 4A, 4B, and 6, the shutter mechanism (97, 98, and 99) includes a shutter 97, an elastic seal 98, and a sealing sheet 99.

The shutter 97 slides (horizontally moves in the left-and-right direction in FIGS. 4A and 4B) to open and close the toner outlet 96a as a fluid supply passage formed in the conveying tube 96 (a housing) of the toner supply device 90. In the present embodiment, the shutter 97 is slidably disposed in the toner supply device 90 as a developer supply device. In the toner supply device 90, a guide holder that slidably holds the shutter 97 is disposed in the vicinity of the conveying tube 96. In a state where the developer housing 54 of the developing device 5Y is coupled to the conveying tube 96 of the toner supply device 90 (in a state where a toner inlet 54a of the developer housing 54 is located below the toner outlet 96a), the shutter 97 is slid to open and close the toner outlet 96a. Such sliding movement of the shutter 97 (the opening and closing operation of the toner outlet 96a) may be manually performed by the operation of an operation lever by a user, or may be automatically performed by detecting whether the conveying tube 96 and the developer housing 54 are connected by a sensor and driving a pinion-and-rack mechanism in the forward and reverse directions.

The shutter 97 is provided with a shutter opening 97a that can communicate with the toner outlet 96a (fluid supply passage) through which toner (one-component developer) as fluid flows out. The toner outlet 96a (fluid supply passage) is formed in the toner supply device 90 (conveying tube 96) that flows out toner as developer toward the inside of the developing device 5Y.

Specifically, when the shutter 97 is moved to the position of FIG. 4A, the shutter opening 97a is not communicated with the toner outlet 96a (and the toner inlet 54a, and an opening 98a and an opening 99a of the elastic seal 98 and the sealing sheet 99 described later), that is, a shutter main surface 97x (see FIG. 6) blocks the toner outlet 96a and the toner inlet 54a. As a result, the toner (fluid) may not be delivered from the toner outlet 96a to the toner inlet 54a. This state is a state when the image forming process described above with reference to FIGS. 1 to 3 is not executed, and particularly, a state when the developing device 5 is not normally set, such as a state when the developing device 5 is removed from the toner supply device 90 (the body of the image forming apparatus 100). When the developing device 5Y is removed from the toner supply device 90 (when the communication between the toner outlet 96a and the toner inlet 54a is released), the toner outlet 96a is closed by the shutter 97, so that the toner leakage from the toner outlet 96a can be restricted. On the other hand, when the shutter 97 is moved to the position illustrated in FIG. 4B, the shutter opening 97a is in communication with the toner outlet 96a (and the toner inlet 54a, the opening 98a of the elastic seal 98, and opening 99a of the sealing sheet 99 described later). Such a configuration enables the toner (fluid) to be delivered from the toner outlet 96a to the toner inlet 54a. The arrow indicated by the broken line illustrated in FIG. 4A and the arrow indicated by the solid line illustrated in FIG. 6 are the opening direction of the shutter 97, and the opposite directions thereof are the closing direction of the shutter 97.

With reference to FIGS. 4A, 4B, and 6, the elastic seal 98 is attached to an edge portion (peripheral portion) of the toner outlet 96a (fluid supply passage) via a double-sided tape to seal a gap between the shutter 97 and the edge portion. The elastic seal 98 is provided with the opening 98a communicating with the toner outlet 96a (fluid supply passage). Specifically, the elastic seal 98 is a substantially rectangular seal made of an elastic material such as foamed polyurethane having a thickness of several millimeters to ten and several millimeters, and is for sealing a gap between the shutter 97 and an edge portion of the toner outlet 96a (a peripheral portion excluding the toner outlet 96a). The elastic seal 98 has the opening 98a having a size equal to (or slightly larger than) the size of the toner outlet 96a not to close the toner outlet 96a.

With reference to FIGS. 4A, 4B, 5, and 6, the sealing sheet 99 is attached to an opposing surface 98x (lower surface) facing the shutter 97 in the elastic seal 98 with a double-sided tape. The sealing sheet 99 is provided with an opening 99a communicating with the toner outlet 96a (fluid supply passage) through the opening 98a of the elastic seal 98. Specifically, the sealing sheet 99 is made of a low-friction material such as polyethylene terephthalate (PET) having a thickness of substantially 0.05 to 1.5 mm, and is a flexible member that can be deformed following the elastic deformation of the elastic seal 98. The sealing sheet 99 is for reducing the sliding resistance with the elastic seal 98 due to the sliding movement (opening-and-closing operation) of the shutter 97 while maintaining the sealing property of the elastic seal 98. The sealing sheet 99 has the opening 99a having a size equal to (or slightly larger than) the toner outlet 96a (and the opening 98a of the elastic seal 98) not to close the toner outlet 96a (and the opening 98a of the elastic seal 98).

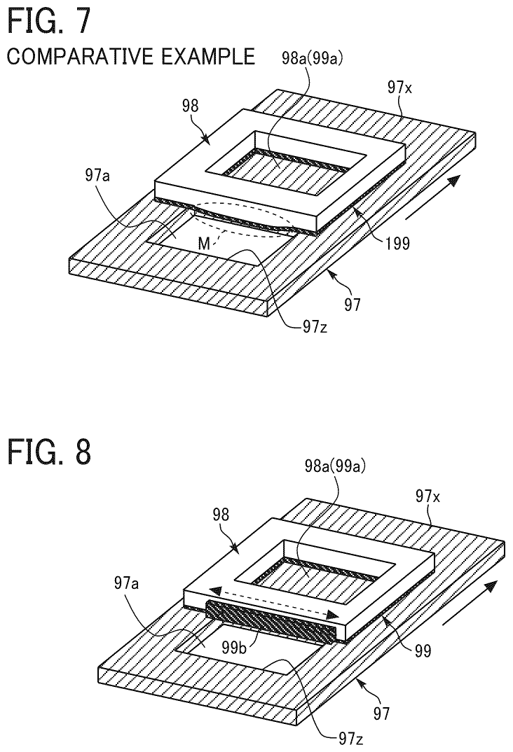

With reference to FIGS. 4A, 4B, 5, and 6, in the shutter mechanism (97, 98, and 99) according to the present embodiment, the sealing sheet 99 has a bent portion 99b bent at a specified angle with respect to an opposing surface 98x (the surface opposing the shutter 97) of the elastic seal 98 in a direction away from the shutter 97 (upward in FIGS. 4A, 4B, and 5) with an end (the end on the left in FIGS. 4A, 4B, and 5) in a direction corresponding to the upstream side in the opening direction (or the downstream side in the closing direction) of the shutter 97 as the bending origin. Specifically, the sealing sheet 99 has a substantially L-shaped cross section, unlike a substantially planar sealing sheet 199 illustrated as a comparative example in FIG. 7. In other words, the sealing sheet 99 has the bent portion 99b extending upward from an end (the end located on the upstream side in the opening direction of the shutter 97 indicated by the arrow in FIG. 6) of a flat surface formed along (to be attached to) the opposing surface 98x of the elastic seal 98. In other words, the bent portion 99b of the sealing sheet 99 is disposed at a position facing an edge portion 97z (the edge portion on the upstream side in the opening direction) of the shutter 97 in the closed state (in the state of FIG. 4A). Such a bent portion 99b can be formed by bending a flat sheet.

As described above, in the shutter mechanism (97, 98, and 99) according to the present embodiment, the bent portion 99b is disposed at the upstream end of the sealing sheet 99 in the opening direction, the sealing sheet 99 adhered to the elastic seal 98 is less likely to be caught by the edge portion 97z of the shutter opening 97a when the shutter 97 is opened and closed (particularly, when the shutter 97 is opened in the direction of the arrow indicated by the dashed line in FIGS. 4A and 4B, or in the direction of the arrow in FIG. 6). As a result, the sealing sheet 99 and the elastic seal 98 are less likely to be rolled up or damaged.

Specifically, as illustrated in FIG. 7 as a comparative example, in a shutter mechanism in which a substantially planar sealing sheet 199 without a bent portion is attached to the elastic seal 98, when the shutter opening 97a reaches a position facing the elastic seal 98, the sealing sheet 199 is deformed downward in an arch shape as surrounded by a dashed line together with the elastic seal 98 due to a step between the shutter main surface 97x and the shutter opening 97a (due to a portion that contacts the shutter main surface 97x and a portion that does not contact the shutter main surface 97x). The portion of the sealing sheet 99 (or the elastic seal 98) deformed downward in an arc shape is caught by the edge portion 97z of the shutter opening 97a when the shutter 97 is opened (the movement in the direction of the arrow in FIG. 7). Thus, the sealing sheet 199 may be rolled up. When such an inconvenience occurs, the sealing sheet 199 and the elastic seal 98 do not function normally, and thus, toner leakage from the toner outlet 96a to the outside may occur. On the other hand, in the present embodiment, the bent portion 99b is disposed at the upstream end of the sealing sheet 99 in the opening direction, so that the stiffness of the bent portion 99b becomes stronger. Thus, the sealing sheet 99 is less likely to be deformed downward in an arc shape together with the elastic seal 98 (the substantially flat state of the lower surface is likely to be maintained). Accordingly, when the shutter 97 is opened (the movement in the direction of the arrow in FIG. 6), the shutter 97 is less likely to be caught by the edge portion 97z of the shutter opening 97a. Thus, the above-described inconvenience is less likely to occur. In the present embodiment, even if the sealing sheet 99 is deformed downward in an arch shape together with the elastic seal 98, the bent portion 99b is disposed at the upstream end of the sealing sheet 99 in the opening direction, so that the bent portion 99b comes contacts the edge portion 97z of the shutter opening 97a when the shutter 97 is opened, and a force that peels off the sealing sheet 99 and the elastic seal 98 is less likely to occur. Thus, the above-described inconvenience is less likely to occur.

In the present embodiment, in order to reduce deformation of the bent portion 99b due to compressive deformation of the elastic seal 98, the bent portion 99b is not adhered to the lateral surface of the elastic seal 98. In contrast, in the case where the deformation of the bent portion 99b due to the compressive deformation of the elastic seal 98 is slight, the bent portion 99b is adhered to the lateral surface of the elastic seal 98, so that even if the bent portion 99b is caught by the edge portion 97z when the shutter is opened, the posture of the bent portion 99b is easily maintained.

With reference to FIG. 5, in the present embodiment, the bent portion 99b of the sealing sheet 99 is bent at substantially 90° with respect to the opposing surface 98x (which is a substantially horizontal surface) of the elastic seal 98. In other words, the bent portion 99b is formed to stand up in a substantially vertical direction. The bent portion 99b is substantially bent in right angle, so that even if the bent portion 99b contacts the edge portion 97z, the possibility that the bent portion 99b is deformed by the contact and caught by the edge portion 97z is reduced, as compared with the case where the bent portion is bent at an angle of 90° or less. Even if the bending angle of the bent portion 99b is 90° or less, an effect close to the above-described effect can be obtained as long as the bending angle is close to 90°.

### First Modification

As illustrated in FIG. 8, in the shutter mechanism (97, 98, and 99) in the first modification, the length of the bent portion 99b of the sealing sheet 99 in the width direction (the direction indicated by the double-headed dashed arrow in FIG. 8, which is the direction orthogonal to the opening-and-closing direction) is shorter than the length of the bent portion 99b of the sealing sheet 99 in FIG. 6. Specifically, the sealing sheet 99 illustrated in FIG. 6 is formed such that the range of the bent portion 99b in the width direction is equal to the range of the elastic seal 98 in the width direction, similarly to the flat surface that contacts the shutter main surface 97x. In contrast, in the sealing sheet 99 according to the first modification illustrated in FIG. 8, the range of the flat surface that contacts the shutter main surface 97x is formed to be equal to the range in the width direction of the elastic seal 98. However, the bent portion 99b is formed to be included in the range in the width direction and to be included in the range in the width direction of the shutter opening 97a. Even in the case of such a configuration, when the shutter 97 is opened (movement in the direction indicated by the arrow in FIG. 8), the sealing sheet 99 (the bent portion 99b) is less likely to be caught by the edge portion 97z of the shutter opening 97a. Thus, the sealing sheet 99 is less likely to be turned up. In the first modification, the amount of material used to manufacture the sealing sheet 99 can be reduced by the amount corresponding to the reduction of the length of the bent portion 99b in the width direction.

### Second Modification

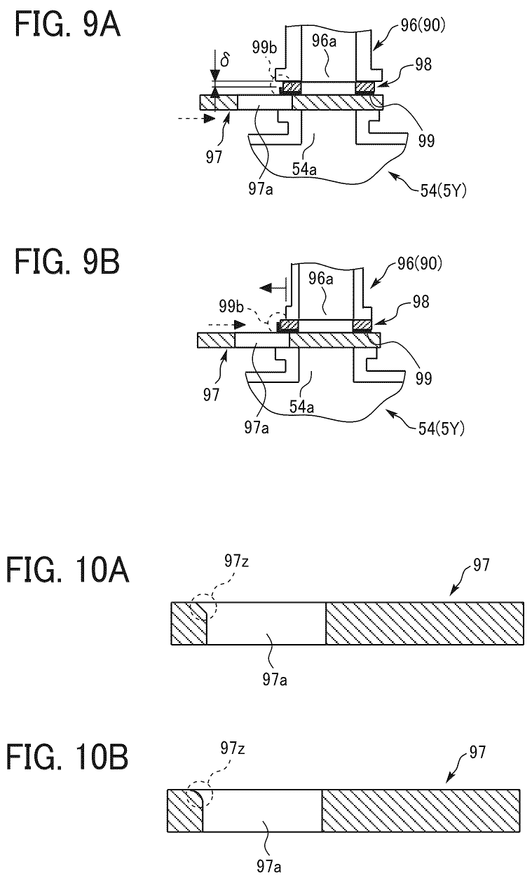

As illustrated in FIG. 9A, in the shutter mechanism (97, 98, and 99) according to the second modification, the bent portion 99b of the sealing sheet 99 is bent in a range in the thickness direction not exceeding the thickness of the elastic seal 98 in a state of being installed in the gap between the shutter 97 and the edge portion of the toner outlet 96a (in a compressed and deformed state). In other words, in the shutter mechanism (97, 98, and 99) in the actual use state, some gap 8 (the gap in the height direction) is formed between the bent portion 99b and the edge portion of the toner outlet 96a (the bottom surface of the conveying tube 96). With such a configuration, even when the elastic seal 98 is compressed between the shutter 97 and the edge portion of the toner outlet 96a, an inconvenience that the upper end of the bent portion 99b interferes with the edge portion of the toner outlet 96a (the bottom surface of the conveying tube 96) and the bent portion 99b buckles is less likely to occur. In addition, in the shutter mechanism (97, 98, and 99) illustrated in FIG. 9B as another embodiment, an end of the sealing sheet 99, which is the bending origin, protrudes from the conveying tube 96, which is the housing in which the toner outlet 96a (fluid supply passage) is formed, to the upstream side in the opening direction (the left in FIG. 9B). In other words, the upstream end of the elastic seal 98 and the sealing sheet 99 illustrated in FIG. 9B in the opening direction does not substantially coincide with the position of the upstream end of the conveying tube 96 in the opening direction, but is located upstream of the position in the opening direction (the direction indicated by the solid arrow in FIG. 9B). Even in such a configuration, an inconvenience that the elastic seal 98 is compressed between the shutter 97 and the edge portion of the toner outlet 96a, and the upper end of the bent portion 99b interferes with the edge portion of the toner outlet 96a (the bottom surface of the conveying tube 96) and the bent portion 99b buckles is less likely to occur.

### Third Modification

As illustrated in FIG. 10A, in the shutter mechanism (97, 98, and 99) according to the third modification, the shutter opening 97a of the shutter 97 is formed such that the edge portion 97z on the upstream side in the opening direction (the left in FIG. 10A) has a C-surface. In the shutter mechanism (97, 98, and 99) illustrated in FIG. 10B as another embodiment, the edge portion 97z on the upstream side in the opening direction of the shutter opening 97a of the shutter 97 is formed in a R-shaped surface. With such a configuration, even if the bent portion 99b contacts the edge portion 97z when the shutter 97 is opened, an inconvenience that the bent portion 99b is caught by the edge portion 97z formed in the C-surface or an R-surface is less likely to occur.

### Fourth Modification

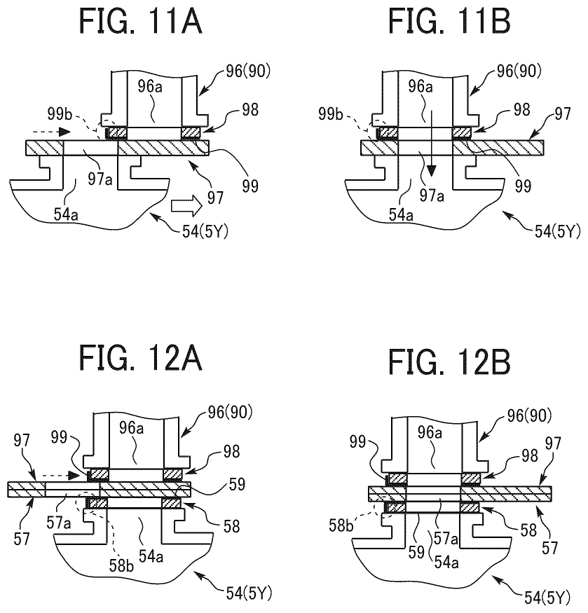

As illustrated in FIGS. 11A and 11B, in the shutter mechanism (97, 98, and 99) in the fourth modification, the shutter 97 opens and closes the toner outlet 5Y in conjunction with the operation of attaching and detaching the developing device 5Y (the toner inlet 54a of the developer housing 54) to and from the toner supply device 90 (the toner outlet 96a of the conveying tube 96). The shutter 97 is slidably movable in the toner supply device 90 (the body of the image forming apparatus 100) is located at a position where the shutter 97 closes the toner outlet 96a by the biasing force of a spring in a state where the developing device 5Y is not set in the toner supply device 90 (the state of FIG. 11A). On the other hand, as the developing device 5Y is set in the toner supply device 90 in the direction indicated by the white arrow, a pushing portion formed on the developing device 5Y pushes the shutter 97 in the direction indicated by the broken line arrow. Thus, the shutter 97 moves to the position where the shutter 97 opens the toner outlet 96a against the biasing force of the spring described above (the state of FIG. 11B). When the developing device 5Y is removed from the toner supply device 90, the reverse operation to the installation operation described above is performed. In the shutter mechanism (97, 98, and 99) as described above, the sealing sheet 99 attached to the elastic seal 98 is less likely to be caught by the edge portion 97z of the shutter opening 97a when the shutter 97 is opened and closed.

### Fifth Modification

As illustrated in FIGS. 12A and 12B, the image forming apparatus 100 according to the fifth modification includes a second shutter mechanism (57, 58, and 59) that opens and closes the toner inlet 54a, in addition to the shutter mechanism (97, 98, and 99) that opens and closes the toner outlet 96a described with reference to FIGS. 4A, 4B, and 6. Specifically, the second shutter mechanism (57, 58, and 59) prevents the toner leakage from the toner inlet 54a when the developing device 5Y is in a state of being taken out from the toner supply device 90, and includes a shutter 57, an elastic seal 58, and a sealing sheet 59. In this case, the toner inlet 54a formed in the developing device 5Y (developer housing 54) into which toner (developer) as fluid is flowed from the toner supply device 90 (developer supply device) functions as a fluid supply passage. The shutter 57 is slidably disposed on the developing device 5Y and has a shutter opening 57a communicating with the toner inlet 54a. The elastic seal 58 is adhered to the edge portion of the toner inlet 54a to seal a gap between the shutter 57 and the edge portion of the toner inlet 54a, and has an opening communicating with the toner inlet 54a. The sealing sheet 59 is adhered to the surface of the elastic seal 58 facing the shutter 57, and has an opening communicating with the toner inlet 54a. The sealing sheet 59 has a bent portion 59b which is bent at a specified angle with respect to the opposing surface of the elastic seal 58 in a direction away from the shutter 57 (downward in FIGS. 12A and 12B) with an end in a direction corresponding to the upstream side in the opening direction of the shutter 57 (left in FIGS. 12A and 12B) as the bending origin. Also in the second shutter mechanism (57, 58, and 59) described above, the sealing sheet 59 adhered to the elastic seal 58 is less likely to be caught by the edge portion of the shutter opening 57a when the shutter 57 is opened and closed.

As described above, the shutter mechanism in the present embodiment includes the shutter 97 that has the shutter opening 97a communicating with the toner outlet 96a (fluid supply passage) through which the toner (fluid) flows out, and slidably moves to open and close the toner outlet 96a. The shutter mechanism in the present embodiment has the opening 98a communicating with the toner outlet 96a, and includes the elastic seal 98 that is adhered to an edge portion of the toner outlet 96a to seal a gap between the shutter 97 and the edge portion of the toner outlet 96a. The shutter mechanism in the present embodiment has the opening 99a communicating with the toner outlet 96a, and includes the sealing sheet 99 that is adhered to the opposing surface 98x facing the shutter 97 in the elastic seal 98. The sealing sheet 99 has a bent portion 99b bent at a specified angle with respect to the opposing surface 98x in a direction away from the shutter 97 with an end in a direction corresponding to the upstream side in the opening direction of the shutter 97 as the bending origin. With such a configuration, when the shutter 97 is opened and closed, the sealing sheet 99 adhered to the elastic seal 98 is less likely to be caught by the edge portion 97z of the shutter opening 97a.

In the present embodiment, the present disclosure is applied to the shutter mechanism (97, 98, and 99) that opens and closes the toner outlet 96a (fluid supply passage) of the conveying tube 96 through which the toner (one-component developer) as a fluid flows out. For example, the present disclosure is applicable to a shutter mechanism that opens and closes a fluid supply passage through which two-component developer as fluid formed of toner and carrier flows out, a shutter mechanism that opens and closes a fluid supply passage through which fresh toner, recycled toner, or untransferred toner as fluid flows out or flows in, and a shutter mechanism that opens and closes a fluid supply passage through which fluid other than developer flows out or flows in. In the image forming apparatus 100 according to the present embodiment, the developing device 5Y is independently attached to and detached from (replaced with) the toner supply device 90. However, a process cartridge in which the developing device 5Y is united with the toner supply device 90 (the unit in which two or more devices among a plurality of devices includes in the image forming device are united) may be attached to and detached from (replaced with) the toner supply device 90. In the present embodiment, the present disclosure is applied to the shutter mechanism (97, 98, and 99) that opens and closes the toner outlet 96a (fluid supply passage) of the toner supply device 90 in which the bottle-shaped toner container 32Y is installed and the developer pump 60 is used, but the configurations of the toner supply device and the toner container are not limited to these configurations. Even in such a case, advantageous effects equivalent to the effects of the above-described present embodiments can be obtained.

A shutter mechanism includes a shutter, an elastic seal, and a sealing sheet. The shutter has a shutter opening and is slidably movable with respect to a fluid supply passage in a first direction to open the fluid supply passage to supply fluid through the fluid supply passage. The elastic seal has a seal opening communicating with the fluid supply passage and a first face adhered to an edge portion of the fluid supply passage to seal a gap between the shutter and the edge portion of the fluid supply passage. The sealing sheet is adhered to a second face of the elastic seal opposite to the first face and is disposed between the elastic seal and the shutter. The sealing sheet has a sheet opening and a bent portion. The sheet opening communicates with the seal opening. The bent portion is bent at an edge of the elastic seal in a second direction away from the shutter toward the fluid supply passage and at an angle with respect to the first direction.

The bent portion has the angle of 90° with respect to a face of the sealing sheet facing the shutter and has a height smaller than a thickness of the elastic seal when the elastic seal is disposed between the shutter and the fluid supply passage.

The edge of the elastic seal protrudes from the edge portion of the fluid supply passage in a third direction, opposite to the first direction, to close the fluid supply passage.

The shutter opening has an inner edge portion having a C-surface or an R-surface.

The sealing sheet has a friction smaller than a friction of the elastic seal.

An image forming apparatus includes the shutter mechanism, a developing device, and a developer supply device. The developer supply device includes the fluid supply passage to supply the fluid including developer to the developing device through the fluid supply passage. The shutter mechanism is disposed between the fluid supply passage of the developer supply device and the developing device.

Note that embodiments of the present disclosure are not limited to the above-described embodiments and it is apparent that the above-described embodiments can be appropriately modified within the scope of the technical idea of the present disclosure in addition to what is suggested in the above-described embodiments. The number, position, and shape of the components described above are not limited to those embodiments described above. Desirable number, position, and shape can be determined to perform the present disclosure.

Aspects of the present disclosure may be, for example, a combination of the first to eighth aspects as follows.

### First Aspect

A shutter mechanism includes a shutter opening (e.g., the shutter opening 97a), a shutter (e.g., the shutter 97), an elastic seal (e.g., the elastic seal 98), and a sealing sheet (e.g., the sealing sheet 99). The shutter opening communicates with a fluid supply passage (e.g., the toner outlet 96a) through which fluid flows out or flows in. The shutter slidably moves to open and close the fluid supply passage. The elastic seal has an opening that communicates with the fluid supply passage and is attached to an edge portion to close a gap between the shutter and the edge portion of the fluid supply passage. The sealing sheet has an opening that communicates with the fluid supply passage and is attached to an opposing surface (e.g., the opposing surface 98x) of the elastic seal opposing the shutter. The sealing sheet has a bent portion (e.g., the bent portion 99b) bent at a specified angle with respect to the opposing surface in a direction away from the shutter with an end in a direction corresponding to an upstream side in an opening direction of the shutter as a bending origin.

### Second Aspect

In the shutter mechanism according to the first aspect, the bent portion (e.g., the bent portion 99b) of the sealing sheet (e.g., the sealing sheet 99) is bent at substantially 90° with respect to the opposing surface (e.g., the opposing surface 98x).

### Third Aspect

In the shutter mechanism according to the first or second aspect, the bent portion (e.g., the bent portion 99b) of the sealing sheet (e.g., the sealing sheet 99) is bent within a range in a thickness direction that does not exceed the thickness of the elastic seal (e.g., the elastic seal 98) in a state of being installed in the gap (e.g., the gap 8).

### Fourth Aspect

In the shutter mechanism according to any one of the first to third aspects, the end of the sealing sheet (e.g., the sealing sheet 99) that becomes the bending origin in the sealing sheet protrudes from a housing (e.g., the conveying tube 96) in which the fluid supply passage (e.g., the toner outlet 96a) is formed toward an upstream side in the opening direction.

### Fifth Aspect

In the shutter mechanism according to any one of the first to fourth aspects, an edge portion (e.g., the edge portion 97z) of the shutter opening (e.g., the shutter opening 97a) on an upstream side in the opening direction is formed in a C-surface or an R-surface.

### Sixth Aspect

In the shutter mechanism according to any one of the first to fifth aspects, the sealing sheet (e.g., the sealing sheet 99) is formed of a low-friction material.

### Seventh Aspect

In the shutter mechanism according to any one of the first to sixth aspects, the fluid is developer. The fluid supply passage (e.g., the toner outlet 96a) is formed in a developer supply device (e.g., the toner supply device 90) that causes the developer to flow out toward an inside of a developing device (e.g., the developing device 5Y), or the developing device into which the developer flows from the developer supply device. The shutter (e.g., the shutter 97) is installed in the developer supply device or the developing device.

### Eighth Aspect

An image forming apparatus (e.g., the image forming apparatus 100) includes the shutter mechanism according to any one of the first to seventh aspects.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A shutter mechanism comprising:
a shutter having a shutter opening, the shutter slidably movable with respect to a fluid supply passage in a first direction to open the fluid supply passage to supply fluid through the fluid supply passage;
an elastic seal having a seal opening communicating with the fluid supply passage, the elastic seal having a first face adhered to an edge portion of the fluid supply passage to seal a gap between the shutter and the edge portion of the fluid supply passage; and
a sealing sheet adhered to a second face of the elastic seal opposite to the first face, the sealing sheet disposed between the elastic seal and the shutter, the sealing sheet having:
a sheet opening communicating with the seal opening, and
a bent portion bent, at an edge of the elastic seal, in a second direction:
away from the shutter toward the fluid supply passage; and
at an angle with respect to the first direction.

2. The shutter mechanism according to claim 1,
wherein the bent portion has the angle of 90° with respect to a face of the sealing sheet facing the shutter.

3. The shutter mechanism according to claim 1,
wherein the bent portion has a height smaller than a thickness of the elastic seal when the elastic seal is disposed between the shutter and the fluid supply passage.

4. The shutter mechanism according to claim 1,
wherein the edge of the elastic seal protrudes from the edge portion of the fluid supply passage in a third direction, opposite to the first direction, to close the fluid supply passage.

5. The shutter mechanism according to claim 1,
wherein the shutter opening has an inner edge portion having a C-surface or an R-surface.

6. The shutter mechanism according to claim 1,
wherein the sealing sheet has a friction smaller than a friction of the elastic seal.

7. An image forming apparatus comprising:
the shutter mechanism according to claim 1;
a developing device; and
a developer supply device including the fluid supply passage to supply the fluid including developer to the developing device through the fluid supply passage,
wherein the shutter mechanism is disposed between the fluid supply passage of the developer supply device and the developing device.
